(19) United States
(12) Patent Application Publication
(10) Pub. No.: US 2011/0016228 A1
(43) Pub. Date: Jan. 20, 2011

(54) APPARATUS, METHOD AND ARTICLE TO PROVIDE ELECTRONIC ACCESS TO INFORMATION ACROSS DISPARATE SYSTEMS IN NETWORKED ENVIRONMENTS

(76) Inventor: Janis L. Harwell, Everett, WA (US)

Correspondence Address: SEED INTELLECTUAL PROPERTY LAW GROUP PLLC, 701 FIFTH AVENUE, SUITE 5400, SEATTLE, WA, 98104-7092, US

(21) Appl. No.: 12/839,996

(22) Filed: Jul. 20, 2010

Related U.S. Application Data
(60) Provisional application No. 61/227,011, filed on Jul. 20, 2009.

(51) Int. Cl. G06F 15/16

(52) U.S. Cl. 709/246

(57) ABSTRACT

An intermediary system may mediate between two or more end user systems to provide access to electronic information in a format desired by one end user where the other end user employs an at least partially incompatible format. The intermediary system employs an intermediary translation table to identify electronic information that requires translation, and to cause the translation of the electronic information into the desired format. The intermediary system advantageously employs a many-to-many approach, allowing end users to take advantage of mappings created by other end users. The approach advantageously places the burden of defining or creating mappings on the end user desiring access to the electronic information of another end user.

### CROSS REFERENCE TO RELATED APPLICATIONS

This application claims benefit under 35 U.S.C. 119(e) to U.S. provisional patent application Ser. No. 61/227,011 filed Jul. 20, 2009 which is incorporated herein by reference in its entirety.

### BACKGROUND

1. Field

This disclosure generally relates to networked computing environments, and particularly to interacting with electronic information stored on various computer-readable media in at least partially incompatible end user formats.

2. Description of the Related Art

Networked systems are ubiquitous. Such systems allow a variety of devices to communicate. For example, traditional networks such as various types of local area networks (LANs) or wide area networks (WANs) allow processor based systems such as computing systems to exchange information, for instance files, electronic documents or other electronic information. Such networks may include extranets, intranets, or the Internet or Worldwide Web (hereinafter the Web), as well as other networks. Processor based systems capable of networked communications include not only traditional computer system, but various other devices, for instance telecommunications devices such as cellular phones and devices commonly referred to as personal digital assistants (PDAs), such as iPHONE®, TREO®, or BLACKBERRY® PDAs. Increasingly, various types of devices have the ability to communicate over multiple networks or to access information from other types of devices. For instance, cellular phones and PDAs are often Internet or Web enabled, allowing such cellular phones to communicate via the Internet and or Worldwide Web, or via other protocols, for instance wirelessly via the IEEE 802.11 protocol or BLUETOOTH® protocol.

Many people and businesses increasingly rely on networks to exchange information. Information is typically stored on one or more computing systems and/or in one or more databases or other forms, associated with a particular end user entity. The electronic information is typically stored in a computer-readable medium, at a location that may be identified by one or more logical addresses. Access to the electronic information may be controlled by one or more computing systems, such as server computing systems, associated with the particular end user entity. The end user entity may employ firewalls and/or other security measures to protect the electronic information, as well as to protect various internal networks associated with the end user entity.

Improvement of business processes such as purchasing, sales, customer service, billing, etc. is closely related to the automatic exchange of data and other electronic information. Success is typically based on agility, that is the ability to react immediately to real-time changes in a market, stimulated by dynamic customer needs or desires.

Very often, electronic information is stored in a way that is proprietary to the particular end user entity or which is at least partially incompatible with other end user entities. For example, delivery conditions such as CFR—Cost and Freight (named destination port), CIF—Cost, Insurance and Freight (named destination port), CPT—Carriage Paid To (named place of destination), or CIP—Carriage and Insurance Paid to (named place of destination) might require specific additional information that is not ready available. Another example is an order of data fields such as date, time, name, address, etc. may vary between different end users. Also for example, an order a data within a given data field may vary between end users, such as an order of a month, day and year. Also for example, the specific representation of information may vary between end users, for instance a month may be represented as January, Jan or 01. As a further example, a semantic meaning of certain electronic information may vary between end users.

Incompatibility may be a problem not only between organizations, but even within a single organization. For example, different divisions or units of a company or other organization may employ different schemas or formats for their electronic information. Incompatibility may even be a problem within a particular division or unit of an organization, for example different application programs (e.g., accounting, inventory, purchasing) employed by the unit may employ incompatible schemas or formats. The high degree of variability in electronic data formats may prevent an end user from electronically accessing, receiving and/or displaying electronic information in the end user's own preferred format, without first undertaking an expensive one-to-one data integration effort.

Hence, new approaches to fostering the exchange of electronic information in networked systems are desirable.

### BRIEF SUMMARY

A method of operating a networked system that includes at least one intermediary translation computing system that has at least one processor and at least one storage medium that stores an intermediary data translation table which maps at least some types of electronic information for at least two end user entities and one intermediary entity that each employ different data schemas from one another may be summarized as including determining by the intermediary translation computing system whether a first instance of electronic information available on a first end user computing system associated with a first one of the end user entities requires translation for use of the first instance of electronic information on a second end user computing system associated with a second one of the end user entities; and electronically translating by the intermediary translation computing system any fields of the first instance of electronic data that may be determined by the intermediary translation computing system to require a translation based on the intermediary data translation table into a form suitable for the second end user computing system. Electronically translating by the intermediary translation computing system any fields of the first instance of electronic data that may be determined by the intermediary translation computing system to require a translation based on the intermediary data translation table may include substituting by the intermediary translation computing system data from a first field of a first end user computing system for a second field of a second end user computing system where the first and the second fields are semantically mapped in the intermediary data translation table.

The method may further include creating a semantic mapping between the first and the second fields by the intermediary translation computing system based on a semantic correspondence between the first and the second fields, where the first and the second fields are each identified by different respective identifiers in a first end user data schema and a second end user data schema, the first and the second end user data schemas used by the first end user computing system and the second end user computing system, respectively. Creating a semantic mapping between the first and the second fields by the intermediary translation computing system based on a semantic correspondence between the first and the second fields may include graphing a number of instances of a potential correspondence between the first and the second fields in respective ones of a number of instances of electronic information. Graphing a number of instances of a potential correspondence between the first and the second fields in respective ones of a number of instances of electronic information may include creating a Petri net graph. Electronically translating by the intermediary translation computing system any fields of the first instance of electronic data that may be determined by the intermediary translation computing system to require a translation based on the intermediary data translation table may include reformatting data in at least one field by the intermediary translation computing system. Reformatting data in at least one field by the intermediary translation computing system may include changing an order of appearance of the data in a field from an order in which the data appears in a field of a first end user data schema used by the first end user computing system or creating a combination of elements from data scheme employed by the first end user computing system into a single field of a data scheme employed by a second end user computing system. Electronically translating by the intermediary translation computing system any fields of the first instance of electronic data that may be determined by the intermediary translation computing system to require a translation based on the intermediary data translation table may include changing an order of an appearance of fields from an order of appearance of fields employed by the first end user computing system. The determining and the electronically translating by the intermediary translation computing system may be executed in response an attempt by the first end user computing system to access the first instance of electronic information stored on a second end user computing system operated by a second entity, the second entity different from the first entity. The determining and the electronically translating by the intermediary translation computing system may be executed in response to an attempt by the first end user computing system to display the first instance of electronic information stored on a second end user computing system operated by a second entity, the second entity different from the first entity. The determining and the electronically translating by the intermediary translation computing system may be executed in response to a transmission to the first end user computing system of the first instance of electronic information stored on a second end user computing system operated by a second entity, the second entity different from the first entity.

The method may further include determining by the intermediary translation computing system whether the first instance of electronic information available on the first end user computing system associated with the first one of the end user entities requires translation for use of the first instance of electronic information on a second end user computing system associated with a second one of the end user entities; electronically translating by the intermediary translation computing system any fields of the first instance of electronic data that are determined by the intermediary translation computing system to require a translation based on the intermediary data translation table into a form suitable for the second end user computing system; and providing at least access to the electronically translated first instance of data to the second end user computing system.

The method may further include determining by the intermediary translation computing system whether a second instance of electronic information available on the second end user computing system associated with the second one of the end user entities requires translation for use of the second instance of electronic information on a first end user computing system associated with a first one of the end user entities; electronically translating by the intermediary translation computing system any fields of the second instance of electronic data that are determined by the intermediary translation computing system to require a translation based on the intermediary data translation table into a form suitable for the first end user computing system; and providing at least access to the electronically translated second instance of data to the third end user computing system.

The method may further include accepting by a third end user computing system associated with a third one of the end user entities at least a portion of an existing mapping of electronic information between a first and a second data schema used by the first and the second end user computing systems, respectively, as defined in the intermediary data translation table.

The method may further include for at least one field for which at least another portion of the existing mapping of electronic information between the first and the second end user computing systems which portion is not accepted by the third end user computing system, adding by the intermediary translation computing system an entry in the intermediary data translation table that maps between a third data schema used by the third end user computing system and at least one of a first or a second data schema used by the first and the second end user computing systems, respectively. Electronically translating by the intermediary translation computing system any fields of the first instance of electronic data that may be determined by the intermediary translation computing system to require a translation based on the intermediary data translation table into a form suitable for the second end user computing system may include translating the fields of the first instance of electronic data via a centrally controlled end user specific data format translation computing subsystem that is part of the intermediary translation computing system.

A networked system may be summarized as including at least one intermediary translation computing system that mediates between a number of end user computing systems, the at least one intermediate computing system having at least one processor and at least one storage medium that stores an intermediary data translation table which maps at least some types of electronic information for multiple ones of the end user computing systems that each employ different schemas from one another, the at least one intermediary translation computing system configured to cause an electronic translation of at least some of a number of fields of a first set of electronic information that is stored by a first one of the end user computing systems and which at least some fields require a translation to be in a form suitable for a second one of the end user computing systems. The at least one intermediary translation computing system may substitute data from a first field of a first one of the schemas which first one of the schemas is used by a first one of the end user computing systems for a second field of a second one of the schemas which second one of the schemas is used by a second one of the end user computing systems where the first and the second fields are mapped in the intermediary data translation table based on a semantic relationship between the first and the second fields to at least partially cause the electronic translation of the at least some of the number of fields of the first set of electronic information. The at least one intermediary translation computing system may be further configured to create a mapping between a first field of a first one of the schemas which first one of the schemas is used by a first one of the end user computing systems and a second field of a second one of the schemas which second one of the schemas is used by a second one of the end user computing systems based at least in part on a semantic correspondence between the first and the second fields as represented by a graph of a number of instances of a potential correspondence between the first and the second fields in respective ones of a number of instances of electronic information. The at least one intermediary translation computing system may reformat data from at least one field of a first one of the schemas which first one of the schemas is used by a first one of the end user computing systems to at least partially cause the electronic translation of the at least some of the number of fields of the first set of electronic information. The at least one intermediary translation computing system may change an order of an appearance of fields from an order of appearance of fields defined by a first one of the schemas which first one of the schemas is used by a first one of the end user computing systems to at least partially cause the electronic translation of the at least some of the number of fields of the first set of electronic information. The at least one intermediary translation computing system may be further configured to cause an electronic translation of at least some of a number of fields of the first set of electronic information that is stored by the first one of the end user computing systems and which at least some fields require a translation to be in a form suitable for a second one of the end user computing systems. The at least one intermediary translation computing system may be further configured to cause an electronic translation of at least some of a number of fields of a second set of electronic information that is stored by the second end user computing system and which at least some fields require a translation to be in a form suitable for a first one of the end user computing systems. In addition, the at least one intermediary translation computing system may be further configured to update the intermediary data translation table to reflect an acceptance by the end user computing systems of at least a portion of an existing mapping of electronic information between a first and a second one of the schemas which first and second one of the schemas are respectively used by the first and the second ones of the end user computing systems, as defined in the intermediary data translation table. Furthermore, the at least one intermediary translation computing system may be further configured to update the intermediary data translation table to add an entry in the intermediary data translation table that maps between a data schema of an additional third end user computing system and at least one of a first or a second one of the schemas which first or second one of the schemas is used respectively by the first and the second ones of the end user computing systems, for at least one field for which at least another portion of the existing mapping of electronic information between the first and the second end user computing systems is not accepted by the third end user computing system.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment including an intermediate translation computing system and a number of end user computing systems associated with various end user entities, communicatively coupled to the intermediate translation computing system by one or more networks, according to one illustrated embodiment.

FIG. 2 is a schematic diagram of an intermediate translation computing system that provides communications via a network, the intermediate translation computing system including a translation server computer system and a data stored on computer-readable media that stores at an intermediate data field translation table, and optionally an inbound and/or outbound data format translation table, according to one illustrated embodiment.

FIG. 3 is a schematic diagram showing interaction between an intermediate data field translation table and various end user data field tables, according to one illustrated embodiment.

FIG. 4 is a schematic diagram showing interaction between an intermediate data field translation table, various end user data field translation tables, and inbound and outbound data format translation tables which are managed by the intermediate translation computing system, according to one illustrated embodiment.

FIG. 5A is a schematic diagram showing an intermediary transaction computing system that interacts to facilitate access to electronic information associated with a first end user entity by a second end user entity, which end user entities employ inconsistent schemas or formats, according to one illustrated embodiment.

FIG. 5B is a graph showing an example of the algebraic Petri nets that simulates a sequential work of two processes.

FIG. 6 is a flow diagram of a method of operating at least one intermediary translation computing system in a networked environment to facilitate an exchange of electronic data between various end user computing systems having incompatible formats by determining whether electronic information requires translation and electronically translating electronic information that requires translation, according to one illustrated embodiment.

FIG. 7 is a flow diagram of a method of electronically translating by substitution for any fields of the first instance of electronic data that are determined to require a translation, according to one illustrated embodiment, which may be employed in performing the electronic translation of the method of FIG. 6.

FIG. 8 is a flow diagram of a method of creating an intermediary data translation table by semantic mapping, according to one illustrated embodiment, which may be employed, for example, in addition to the method of FIG. 6.

FIG. 9 is a flow diagram of a method of graphing to create a semantic map, according to one illustrated embodiment, which may be employed as part of the semantic mapping of the method of FIG. 8.

FIG. 10 is a flow diagram of a method of reformatting data to electronically translate any fields of the first instance of electronic data that are determined to require a translation, according to one illustrated embodiment, which may be employed as part of the electronic translating of the method of FIG. 6.

FIG. 11 is a flow diagram of a method of electronically translating any fields of the first instance of electronic data that are determined to require a translation by changing an order of appearance of data in a field, according to one illustrated embodiment, which may be employed as part of the electronic translating of the method of FIG. 6.

FIG. 12 is a flow diagram of a method of electronically translate any fields of the first instance of electronic data that are determined to require a translating any fields of the first instance of electronic data that are determined to require a translation by changing an order of appearance of fields, according to one illustrated embodiment, which may be employed as part of the electronic translating of the method of FIG. 6.

FIG. 13 is a flow diagram of a method of operating at least one intermediary translation computing system in a networked environment to facilitate an exchange of electronic data between various end user computing systems having incompatible formats by determining whether electronic information requires translation and electronically translating electronic information that requires translation, which may be employed in addition to the method of FIG. 6.

FIG. 14 is a flow diagram of a method of operating at least one intermediary translation computing system in a networked environment to facilitate an exchange of electronic data between various end user computing systems having incompatible formats, which may be employed in addition to the method of FIG. 6.

FIG. 15 is a flow diagram of a method of operating at least one intermediary translation computing system in a networked environment to facilitate an exchange of electronic data between various end user computing systems having incompatible formats, which may be employed in addition to the method of FIG. 6.

FIG. 16 is a flow diagram of a method of operating at least one intermediary translation computing system in a networked environment to facilitate an exchange of electronic data between various end user computing systems having incompatible formats, which may be employed in addition to the method of FIG. 15.

FIG. 17 is a flow diagram of a method of any fields of the first instance of electronic data that are determined to require a translation, which may be employed as part of the electronic translation of the method of FIG. 6.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and servicer computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

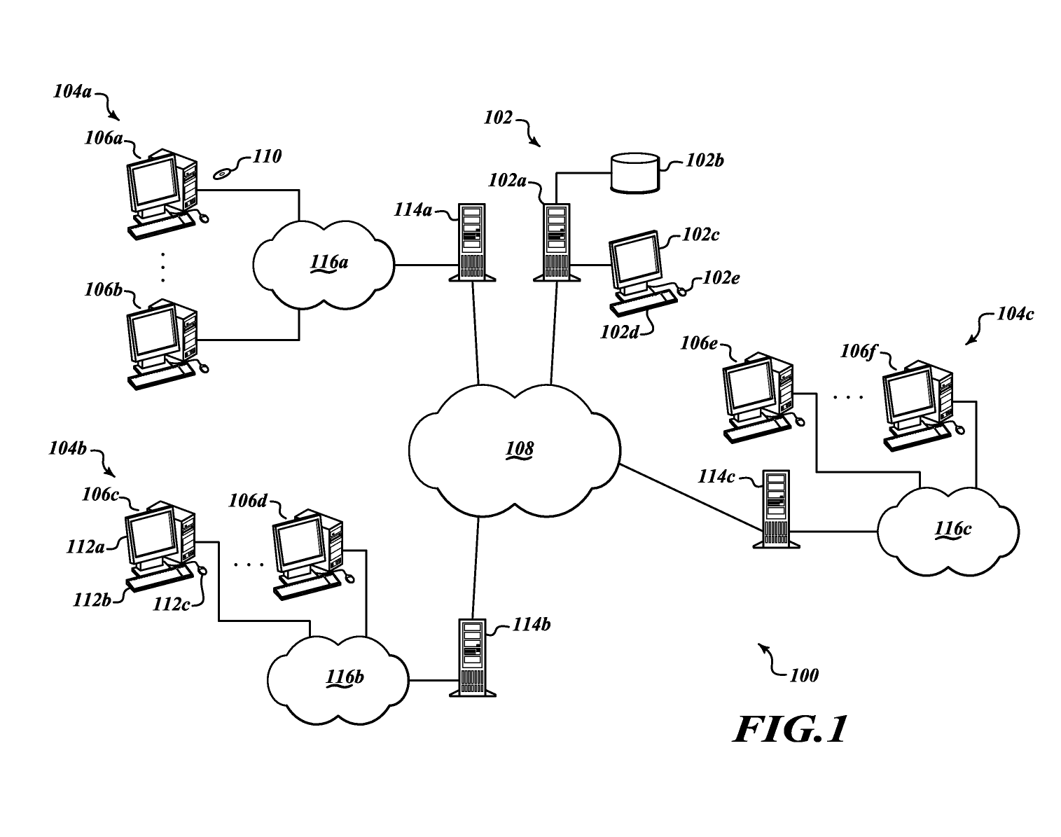

FIG. 1 shows a network environment 100, according to one illustrated embodiment.

The network environment 100 includes at least one intermediary translation computing system 102. The intermediary translation computing system 102 may include a number of components. For example, the intermediary translation computing system 102 may include one or more intermediary translation server computers 102a, one or more processor- or computer-readable storage medium 102b, and optionally one or more user interfaces for example including a display 102c, a keyboard 102d and one or more pointing devices such as a mouse 102e. The intermediary translation server computer(s) 102a include one or more processors that execute instructions (i.e., server software) stored on computer-readable media to provide translation and server functions in the network environment 100. For example as described in detail herein, the intermediary translation server computer system(s) 102a may identify electronic information employed by an end user entity that requires translation in order to be accessed by another end user entity, and may translate the identified electronic information based at least in part on an intermediary data translation table stored in or as one or more databases on processor- or computer-readable storage media, for example on the processor- or computer-readable storage medium 102b.

The network environment 100 includes a number of end user computing environments 104a-104c (only three shown, collectively 104). The end user computing environments 104 may each be associated with a respective end user entity. End user entities may, for example, take the form of a corporation, division, subsidiary, company, partnership, venture sole proprietorship, business, government, charity, nonprofit organization or other organization. End user entities may, for example, additionally or alternatively take the form of individuals.

The end user computing environments 104 are selectively communicatively coupled to the intermediary translation computing system 102 via one or more intermediary communications networks 108 (only one shown).

The one or more intermediary communications networks 108 may take a variety of forms. For instance, the intermediary communications networks 108 may include wired, wireless, optical, or a combination of wired, wireless and/or optical communications links. The one or more intermediary communications networks 108 may include public networks, private networks, unsecured networks, secured networks or combinations thereof. The one or more intermediary communications networks 108 may employ any one or more communications protocols, for example TCP/IP protocol, UDP protocols, IEEE 802.11 protocol, as well as other telecommunications or computer networking protocols. The one or more intermediary communications networks 108 may include what are traditionally referred to as computing networks (e.g., LAN, WAN) and/or what are traditionally referred to as telecommunication networks (e.g., POTS, cellular) or combinations thereof. In at least one embodiment, the one or more intermediary communications networks 108 includes the Internet, and in particular, the Worldwide Web or (referred to herein as “the Web”). While denominated herein as being an “intermediary” communications network, such is not meant to imply or suggest that the intermediary communications network 108 is owned by or under control of an entity that operates the intermediary translation computing system 102. Rather, the term “intermediary” is used to denote a relative position of a device which the term modifies, with respect to two or more end user entities or end user computing systems 104, where that device is mediating between two or more end users.

The end user computing environments 104 may include one or more end user computer systems 106a-106f (collectively 106). The end user computing environments 104 are each illustrated with two end user computer systems 106 and a set of ellipses to indicated additional end user computer systems that have not been illustrated. However, each end user computing environment 104 may include a greater or fewer number of end users computer systems 106.

The end user computer systems 106 may include one or more processors that execute one or more sets of instructions (e.g., applications, browser or other communications instructions) stored on any of a variety of processor- or computer-readable media 110 (only one illustrated in FIG. 1). While illustrated as an optically readable disc, the processor- or computer-readable media 110 may take any variety of forms, including but not limited to spinning media such as magnetic hard disks or floppy disks, or solid state memory devices such as read only memory (ROM) or random access memory (RAM), or flash memory, to name a few. The end user computer systems 106 may include user interface devices, for example displays 112a, keyboards 112b and/or pointing devices, such as a mouse 112c (only one of each user interface device called out in FIG. 1). The end user computer systems 106 may take a variety of forms, for instance desktop or laptop personal computers, work stations, mini-computers, mainframe computers, or other computational devices with microprocessors or microcontrollers which are capable of networked communications. As noted in the background, various other types of processor based devices (e.g., PDAs, cellular phones) are capable of communications via various network architectures and protocols. Thus, the end user computer systems 106 may take the form of such processor based devices.

One or more of the end user computing environments 104 may include one or more networking devices. For example, the end user computing environments 104 may each include one or more routers, bridges and/or gateways 114a-114c (collectively 104) that provide communications between the end user computer systems 106 and the intermediary communications network 108. The end user computing environments 104 may also include one or more end user networks 116a-116c (collectively 116), for example an intranet or extranet, to communicatively couple the end user computer systems 106 to the intermediary communications network 108 via the routers, bridges and/or gateways 114a-114c. Thus the end user computer systems 106 may be communicatively coupled to the intermediary communications network 108 either directly, or via some intervening network devices, such as the routers, bridge, gateways 114 and/or via one or more servers. The end user computer systems 106 may be communicatively coupled to the intermediary communications network 108 via wired, wireless or a combination of wired and wireless communications channels.

The intermediary translation server computer(s) 102a of the at least one intermediary translation computing system 102 execute instructions stored on computer-readable media that cause the intermediary translation server computers to identify electronic information employed by one end user entity computing system that requires translation in order to be accessed by another end user entity computing system. The server computer(s) 102a may translate the identified electronic information based at least in part on an intermediary data translation table. As previously noted the intermediary data translation table may be stored in or as one or more databases on processor- or computer-readable storage media, for example the processor- or computer-readable storage medium 102b. While discussed herein in the singular, in some embodiments that translation information or relationships may be stored in more than one table, the group of tables being denominated as the intermediary data translation table.

The intermediary translation server computer(s) 102a of the at least one intermediary translation computing system 102 advantageously implement a many-to-many translation system. Thus, the intermediary data translation table may allow one end user to take advantage of translations previously set up between two other end users.

Two or more formats may be mapped to a single translation table, and the translation table may likewise be mapped to two or more data format tables, associated with respective end user entities or end user computing systems. The reverse mapping of said translation table to end users' data format tables will allow two or more end user entities which employ incompatible or different formats from each other, to electronically exchange information. The reverse mapping may also allow a first end user entity to electronically access, receive, view or display electronic information of another end user entity at the first end user entity's own preferred format, as if the incompatibility did not exist. The instructions may cause the intermediary translation server computer(s) 102a to identify a single instance of electronic information for translation which may be identified by or associated with a logical address. The instructions may also cause the intermediary translation server computer(s) 102a to translate the electronic information or at least provide instructions for translating the electronic information. For example, instructions may cause the intermediary translation server computer(s) 102a to associate or provide a relationship between a first field associated with a first end user entity with a second field associated with a second user entity. Also for example, the instructions may cause the intermediary translation server computer(s) 102a to change an order of data or other information in a given data field for use by a second end user entity from that employed by the first end user entity.

The detailed structure and operation of the one or more intermediary translation computing system 102 including intermediary data translation table to facilitate access to electronic information between various end user computing environments are discussed in detail below.

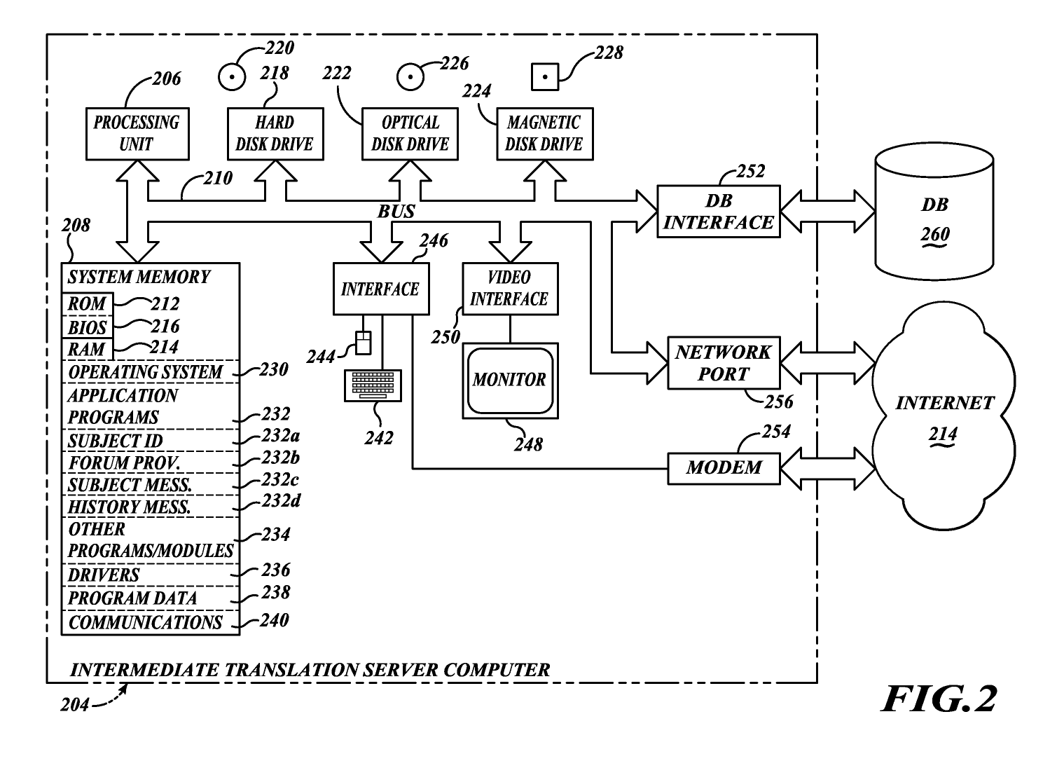

FIG. 2 and the following discussion provide a brief, general description of an exemplary intermediary translation computing system 200 in which the various illustrated embodiments can be implemented. The subject intermediary translation computing system 200 may, for example, implement the various functions and operations discussed immediately above in reference to FIG. 1.

Although not required, some portion of the embodiments will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices for instance Web enabled cellular phones or PDAs, multiprocessor systems, microprocessor-based or programmable consumer electronics, personal computers (“PCs”), network PCs, minicomputers, mainframe computers, and the like. The embodiments can be practiced in distributed computing environments where tasks or modules are performed by remote processing devices, which are linked through a communications network. In a distributed computing environment, program modules may be located in both local and remote memory storage devices.

The intermediary translation computing system 200 may include one or more intermediary translation server computers 204 (only one illustrated in FIG. 2). The intermediary translation server computer(s) 204 may take the form of a conventional PC or server executing instructions. The intermediary translation server computer 204 includes a processing unit 206, a system memory 208 and a system bus 210 that couples various system components including the system memory 208 to the processing unit 206. The intermediary translation server computer 204 will at times be referred to in the singular herein, but this is not intended to limit the embodiments to a single system, since in certain embodiments, there will be more than one system or other networked computing device involved. Non-limiting examples of commercially available systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 206 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 2 are of conventional design. As a result, such blocks need not be described in further detail herein, as they will be understood by those skilled in the relevant art.

The system bus 210 can employ any known bus structures or architectures, including a memory bus with memory controller, a peripheral bus, and a local bus. The system memory 208 includes read-only memory (“ROM”) 212 and random access memory (“RAM”) 214. A basic input/output system (“BIOS”) 216, which can form part of the ROM 212, contains basic routines that help transfer information between elements within the control subsystem 304, such as during start-up. Some embodiments may employ separate buses for data, instructions and power.

The intermediary translation server computer 204 also includes a hard disk drive 218 for reading from and writing to a hard disk 220, and an optical disk drive 222 and a magnetic disk drive 224 for reading from and writing to removable optical disks 226 and magnetic disks 228, respectively. The optical disk 226 can be a CD or a DVD, while the magnetic disk 228 can be a magnetic floppy disk or diskette. The hard disk drive 218, optical disk drive 222 and magnetic disk drive 224 communicate with the processing unit 206 via the system bus 210. The hard disk drive 218, optical disk drive 222 and magnetic disk drive 224 may include interfaces or controllers (not shown) coupled between such drives and the system bus 210, as is known by those skilled in the relevant art. The drives 218, 222, 224, and their associated computer-readable media 220, 226, 228, provide nonvolatile storage of computer-readable instructions, data structures, program modules and other data for the intermediary translation server computer 204. Although the depicted intermediary translation server computer 204 employs hard disk 220, optical disk 226 and magnetic disk 228, those skilled in the relevant art will appreciate that other types of computer-readable media that can store data accessible by a computer may be employed, such as magnetic cassettes, flash memory cards, Bernoulli cartridges, RAMs, ROMs, smart cards, etc.

Program modules can be stored in the system memory 208, such as an operating system 230, one or more application programs 232, other programs or modules 234, drivers 236 and program data 238.

The application programs 232 may, for example, include identification logic 232a, translation logic 232b, new relationship mapping logic 232c, and existing relationship mapping logic 232d. The logic 232a-232d may, for example, be stored as one or more executable instructions. As discussed in more detail below, the identification logic 232a may include logic or instructions to parse contents of electronic information, determine whether a piece or instance of electronic information requires translation for access by a particular end user entity or end user computer. Such, may for example, allow identification of files, electronic messages or individual pieces of data or other information based at least in part on the intermediary translation table. The translation logic 232b may include logic or instructions to associate a data field or data field characteristic of one end user entity with a data field or data field characteristic of another end user entity. As discussed in more detail below, the association may be defined, in whole or in part, in the intermediary translation table. As discussed in detail below, the new relationship mapping logic 232c may include logic or instructions to allow an end user entity or end user computer to define a relationship or otherwise associate a data field or data field characteristic used by the end user entity with a data field or data field characteristic used by another end user entity. Such allows an end user to define or form new relationships, particular where existing relationships or associations do not already exist. As discussed in more detail below, the association may be defined, in whole or in part, in the intermediary translation table. As discussed in detail below, the existing relationship mapping logic 232c may include logic or instructions to allow an end user entity accept or end user computer to accept or adopt an already existing relationship or association between data field or data field characteristics of two other end user entities. Such advantageously allows end users to take advantage of relationships and associations previously defined or formed by other end user entities. Such application programs 232 may execute the logic 232a-232d as methods or processes set out in the various flow charts discussed below.

The system memory 208 may also include communications programs 240, for example a server program and/or a Web client or browser program that permit the intermediary translation server computer 204 to access and exchange data with other systems or components, such as end user computer systems 106 (FIG. 1), Web sites on the Internet, corporate intranets, extranets, or other networks as described below. The communications programs 240 in the depicted embodiment is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 2 as being stored in the system memory 208, the operating system 230, application programs 232, other programs/modules 234, drivers 236, program data 238 and server and/or browser 240 can be stored on the hard disk 220 of the hard disk drive 218, the optical disk 226 of the optical disk drive 222 and/or the magnetic disk 228 of the magnetic disk drive 224. A user can enter commands and information into the intermediary translation server computer 204 through input devices such as a touch screen or keyboard 242 and/or a pointing device such as a mouse 244. Other input devices can include a microphone, joystick, game pad, tablet, scanner, biometric scanning device, etc. These and other input devices are connected to the processing unit 206 through an interface 246 such as a universal serial bus (“USB”) interface that couples to the system bus 210, although other interfaces such as a parallel port, a game port or a wireless interface or a serial port may be used. A monitor 248 or other display device is coupled to the system bus 210 via a video interface 250, such as a video adapter. Although not shown, the control subsystem 204 can include other output devices, such as speakers, printers, etc.

The intermediary translation server computer 204 operates in a networked environment 100 (FIG. 1) using one or more of the logical connections to communicate with one or more remote computers, servers and/or devices via one or more communications channels, for example, one or more networks, for example the Internet and/or Web 214. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a WAN networking environment, the intermediary translation server computer 204 may include a modem 254 for establishing communications over the WAN, for instance the Internet or Web 214. The modem 254 is shown in FIG. 2 as communicatively linked between the interface 246 and the Internet or Web 214. Additionally or alternatively, another device, such as a network port 256, that is communicatively linked to the system bus 210, may be used for establishing communications over the Internet or Web 214. Further, one or more network interfaces 252, that are communicatively linked to the system bus 210, may be used for establishing communications over a LAN. In particular, a database interface 252 may provide communications with one or more databases stored on one or more computer-readable media 260. Such may include one or more intermediary data translation tables and/or end user entity specific data format tables.

In a networked environment 100 (FIG. 1), program modules, application programs, or data, or portions thereof, can be stored in another server computing system (not shown). Those skilled in the relevant art will recognize that the network connections shown in FIG. 2 are only some examples of ways of establishing communications between computers, and other connections may be used, including wirelessly. In some embodiments, program modules, application programs, or data, or portions thereof, can even be stored in one of the end user computer systems 106 (FIG. 1) or other devices, for example on a computer-readable storage medium of the end user computer system or other device.

For convenience, the processing unit 206, system memory 208, network port 256 and interfaces 246, 252 are illustrated as communicatively coupled to each other via the system bus 210, thereby providing connectivity between the above-described components. In alternative embodiments of the intermediary translation server computer 204, the above-described components may be communicatively coupled in a different manner than illustrated in FIG. 2. For example, one or more of the above-described components may be directly coupled to other components, or may be coupled to each other, via intermediary components (not shown). In some embodiments, system bus 210 is omitted and the components are coupled directly to each other using suitable connections.

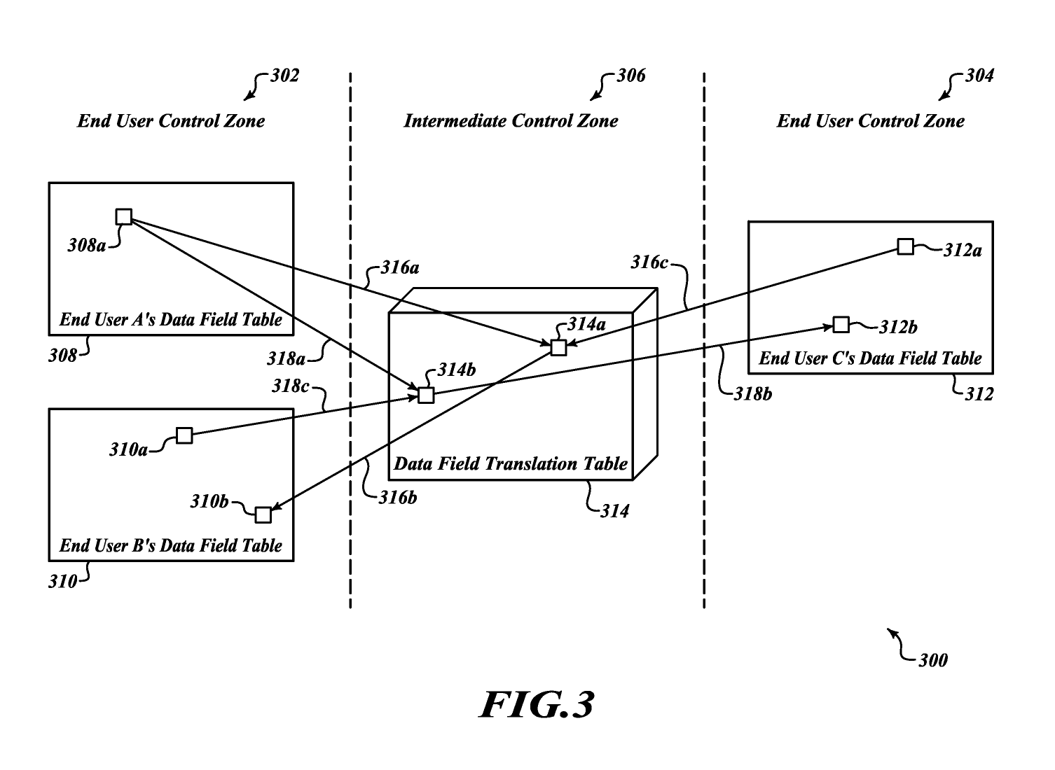

FIG. 3 shows a computing environment 300 that allows end user entities to access electronic information, according to one illustrated embodiment. In particular, FIG. 3 illustrates the many-to-many mappings that may be advantageously realized by at least some of Applicant's disclosed embodiments.

The computing environment may be thought of as consisting of three zones, a first end user control zone 302, a second end user control zone 304, and an intermediate control zone 306 that mediates between the first and the second end user control zones, 302, 304. Such zones may not reflect any actual physical boundaries, but rather represent the function of the intermediary in mediating access to electronic information between two or more end user entity associated systems.

A first end user entity may be associated with a first end user computing system that includes one or more processors and one or more processor- or computer-readable storage media, some of which storage media may store electronic information in a first format defined by a first schema. In particular, the first end user computing system may employ a first end user's data field table 308 to store electronic information 308a according to the first schema.

A second end user entity may be associated with a second end user computing system that includes one or more processors and one or more processor- or computer-readable storage media, some of which storage media may store electronic information in a second format defined by a first schema. The second format may be different from the first format, hence the second format is denominated as being at least partially incompatible with the first format. In particular, the second end user computing system may employ a second end user's data field table 310 to store electronic information 310a, 310b according to the second schema.

In some embodiments, a third end user entity may be associated with a third end user computing system that includes one or more processors and one or more processor- or computer-readable storage media, some of which storage media may store electronic information in a third format defined by a first schema. The third format may be different from the first and second formats, hence the third format is denominated as being incompatible with the first and second formats. In particular, the third end user computing system may employ a third end user's data field table similar to 312 to store electronic information 312a, 312b according to the third schema.

An intermediary translation computing system includes one or more processors and one or more processor- or computer-readable storage media, some of which storage media may store a data field translation table 314. The data field translation table 314 relates data fields 308a, 310a, 310b, 312a, 312b of two or more end user entities (e.g., first and second end user entities) which end user entities use different and at least partially incompatible formats.

For example, the intermediary translation data field table 314 may have an entry or field 314a that relates a data field 308a from the first entity's data field table 308 to a data field 310a of the second entity's data field table 310, as illustrated by the path defined by arrows 316a, 316b. Likewise, the intermediary translation data field table 314 may have an entry or field 314a that relates a data field 312a from the third entity's data field table 312 to the data field 310a of the second entity's data field table 310, as illustrated by the path defined by arrows 316c, 316b.

Also for example, the intermediary translation data field table 314 may have an entry or field 314b that relates the data field 308a from the first entity's data field table 308 to a data field 312b of the third entity's data field table 312, as illustrated by the path defined by arrows 318a, 318b. Likewise, the intermediary translation data field table 314 may have an entry or field 314a that relates a data field 310b from the second entity's data field table 310 to the data field 312b of the third entity's data field table 312, as illustrated by the path defined by arrows 318c, 318b.

While FIG. 3 illustrates tables associated with two end user entities, the teachings are applicable to any number of end user entities, and the benefits afforded by the approached described herein are enhanced as the system is scaled upward. More end user entities will typically mean more previously defined relationships that other end user entities may take advantage of by accepting such relationships rather than having to defined new relationships. For example, the intermediary translation computing system may present one or more existing relationships, mappings or translations for an end user entity to select from. Such may represent relationships, mappings or translations between data fields of schemas of two other end user entities, allowing the third end user entity to take advantage of previously defined relationships, mappings or translations. Such may be graphically displayed, for example in a pull-down menu, a dialog box, a table, or a graph. Thus, the intermediate translation computing system may identify existing relationships, mappings or translations between certain fields of two schemas, and suggest an identical or similar relationship, mapping or translation between a third schema and at least one of the two schemas. Such may be based on a perceived semantic relationship between the fields of the schemas. For example, a number of fields may appear to represent an entity identifier (e.g., tax number, corporate name, account number).

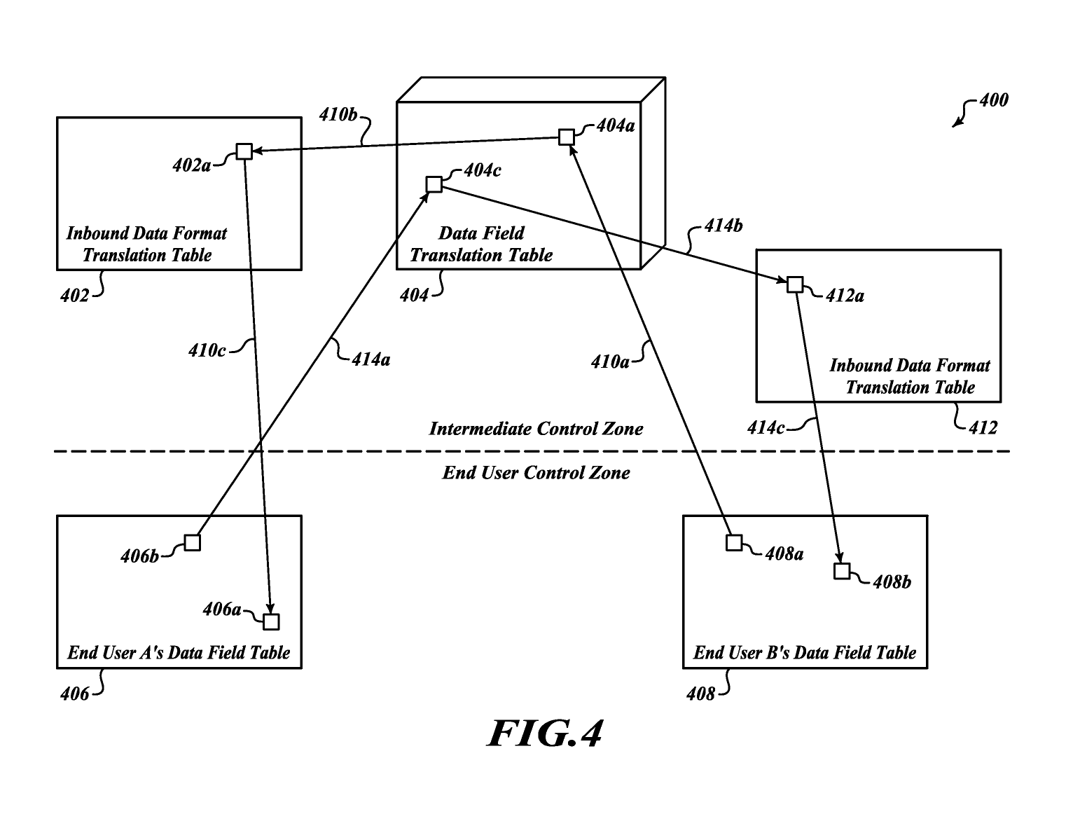

FIG. 4 shows a computing environment 400 that allows end user entities to access electronic information, according to one illustrated embodiment.

In particular, FIG. 4 illustrates the use of end user entity specific in-bound data format translation tables which may be advantageously employed by at least some of Applicant's disclosed embodiments.

A first entity specific in-bound data format translation table 402 may include data or fields 402a, that define a relationship between data or a data field 404a of an intermediary data field translation table 404 and data or a data field 406a of a first end user's data field table 406. As described above in reference to FIG. 3, the data or data field 404a of the intermediary data field translation table 404 may include data or data fields that define a relationship between the data or data field 406a of the first end user entity's data field table 406 and data or a data field 408a of a second end user entity's data field table 408. Thus, data or a data field 408a associated with the second end user entity may be related with data or data field 406a associated with the first end user entity by a series of relationships, for example as illustrated by a path defined by arrows 410a-410c.

A second entity specific in-bound data format translation table 412 may include a data or fields 412a, that defines a relationship between data or a data field 404c of the intermediary data field translation table 404 and data or a data field 408b of the second end user's data field table 408. As described above in reference to FIG. 3, the data or data field 404b of the intermediary data field translation table 404 may include data or a data field that defines a relationship between the data or data field 408b of the second end user entity's data field table 408 and data or a data field 406b of the first end user entity's data field table 406. Thus, data or a data field 406b associated with the first end user entity may be related with data or data field 408b associated with the second end user entity by a series of relationships, for example as illustrated by a path defined by arrows 414a-414c.

The use of various entity specific in-bound data format translation tables 402, 412 advantageously allows electronic information formatted for one end user entity to be translated into a form suitable for the specific end user entity that desires access to that electronic information. The various entity specific in-bound data format translation tables 402, 412 may additionally or alternatively be end user application specific, allowing translations to be based on which specific application of a number of applications the end user will employ to access the electronic information. Thus, for example, one translation may be performed for an accounting package application, while a different translation may be performed for an inventory related application, yet a still different translation for a shipping to tracking related application.

The relationships may initially be defined by one end user entity or system associated with the end user entity in order to access or receive electronic information of another end user entity. A further end user entity may take advantage of the relationship previously defined by the one end user entity. The burden of defining relationships may fall on the end user entity that would like access to the electronic information in that end user entity's desired format or would be done in cooperation with an intermediate entity. As more end user entities define relationships, it become increasingly likely that a desired relationship will already exist, having been previously defined by another end user entity.

Thus a many-to-many approach is employed in which a single data field translation table is linked to a single data format system for each end user entity. An end user entity or associated end user entity computing system trying to send data to another end user entity or associated end user entity computing system only needs to interface with the data field translation table. The data field translation table routes the data to a centrally-managed data format translation system for the end user entity or end user entity associated computing system who will be receiving or accessing the electronic information. Consequently, the originators of the electronic information advantageously do not have to perform these tasks. Thus, electronic information being accessed from one end user entity to another end user entity moves through the single, centrally controlled intermediate data field translation table to a centrally-controlled data format translation system in which the data in each field is evaluated to determine whether it is in the format required by the recipient before being sent on to its destination.

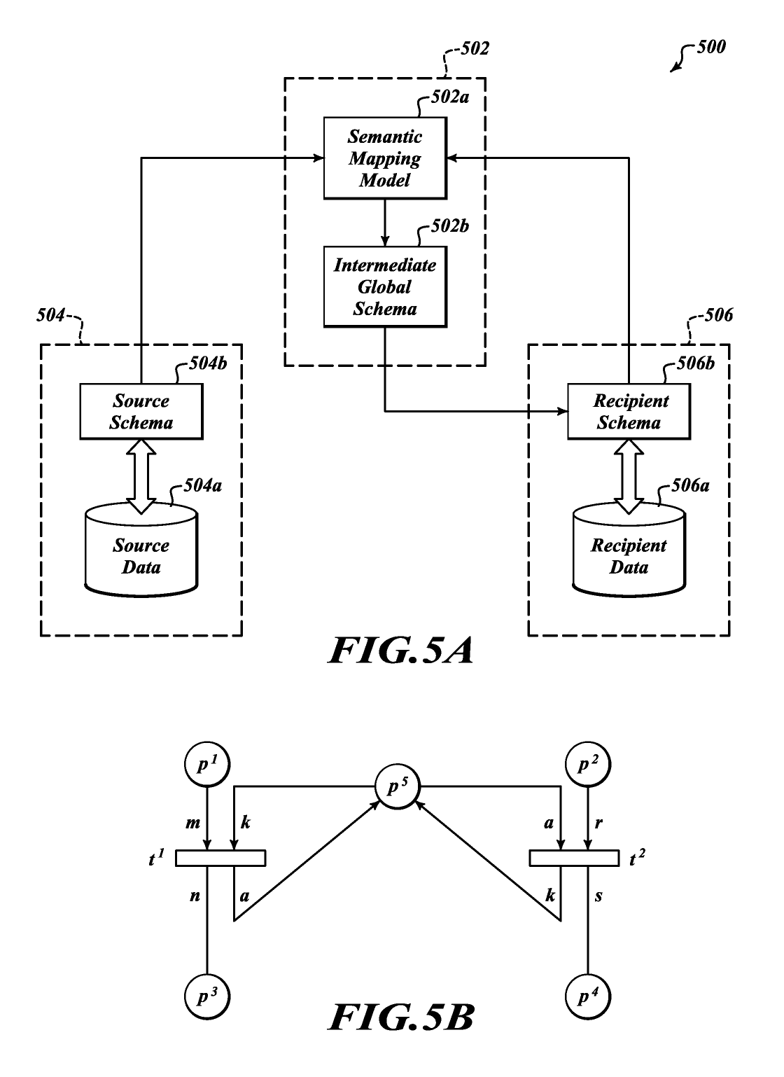

FIG. 5A shows a computing environment 500 in which an intermediary transaction computing system 502 interacts to facilitate access to electronic information associated with a first end user entity 504 by a second end user entity 506, according to one illustrated embodiment.

The first end user entity 502 includes one or more end user computing system(s) and which store electronic information, for instance in the form of source data 504a which may be stored as a source data database. The end user computing system(s) stores the information per a source schema 504b, which defines relationships between the source data or other information in the source data database.

The second end user entity 506 includes one or more end user computing system(s) and which store electronic information, for instance in the form of recipient data 506a which may be stored as a recipient data database. The end user computing system(s) stores the information per a recipient schema 560b which defines relationships between the recipient data or other information in the recipient data database. Generally, the recipient schema 506b at least in part is incompatible with the source schema 504b.

An intermediary transaction computing system 502 acts as an intermediary between the source and recipient schemas 504b, 506b. In particular, the intermediary transaction computing system includes a semantic mapping model 502a that semantically maps between the source and recipient schemas 504b, 506b. The intermediary transaction computing system 502 also includes an intermediate global schema 502b.

The database schemas 502b, 504b, 506b may each be stored on one or more physical media, for example computer-readable storage media. The database schemas 502b, 504b, 506b may each be stored locally to the respective computing system, or may be stored remotely therefrom, or portions may be stored locally while other portions stored remotely. The database schemas 502b, 504b, 506b each employ a set of data structures that provide logical relationships between various elements of data. While illustrated as several tables, the database schemas 502b, 504b, 506c may each include additional tables, may eliminate some tables and/or employ other tables. Additionally, or alternatively, the database schemas 502b, 504b, 506b may employ data structures other than, or in addition to, tables. For example, the data schemas 502b, 504b, 506b may employ records, fields, and pointers, or other data structures.

The intermediate global database schema 502 associates or defines logical relationships between the source schema 504b and the recipient schema 506b. The electronic information may be represented by identifiers. The identifiers may, for example, take the form of a logical address of a location of the electronic information as stored on a computer-readable medium, or a pointer to such a logical address. The logical address may, for example, take the form of a network address that identifies a location of the electronic information or may be an address of a database and a key that provides access to the electronic information. Identifiers may take a variety of forms, for example alphanumeric strings, which may, or may not, be human recognizable (e.g., text).

In some embodiments, the intermediate computing system 502 may routinely survey or “crawl” the network(s) for electronic information, for example to create or update the semantic mapping. In some embodiments, the intermediate computing system 502 may create or update the semantic mapping specific mapping instructions or information received from one of the end user entity computing systems 504, 506.

In generally, a schema can be defined as an abstract collection of metadata, consisting of a set of schema components, attribute declarations and type definitions. The components are usually created by processing a collection of schema documents, which contain the definitions of the components. Schema documents can have hierarchical organization: low level schema components belong to related high level schemas), and subsequently to a schema document as a whole. A schema document may include other schema documents that may be imported from a different schema documents). In the present case, a schema consists of a set of related elements, such as tables, columns, or attributes.

Mapping of schemas is manipulation that takes two schemas as input and returns a mapping that identifies corresponding elements in at least two schemas in the form of a logical relationship or correspondence. In other words, the mapping is an identification of integration points between different schemas. For example, a mapping can consist of a set of pairs, each of which denotes that certain elements of a schema 51 are related to certain elements of a schema S2.

Since semantic mapping is intrinsically a subjective process, there may be several conceivable mappings between schemas and therefore, a user training phase might be useful on initial stage of mapping.

The semantic mapping can be represented as an open causal dynamic system. Such may, for example, be implemented via mathematical graphing. For instance, such may be implemented via colored Petri nets, in which one can associate essentially arbitrary collections of data with Petri net tokens, so long as there are a strong type system and appropriate restrictions on the expressions used in the net.

Ordinary Petri nets are a type of bipartite, directed and weighted graph, which can acquire the dynamics of a discrete events driven system. The Petri nets provide a compact representation of a system of relationships because such nets do not represent explicitly all the space or states from the modeled system. Even an ordinary Petri net is capable of describing a multi-faceted mapping process between multiple schemas while taking into account quantitative aspects of the mapping.

An ordinary Petri net is PN=(P, T, Pre, Post, M), formed by:
a finite set of places P;
a finite set of transitions T;
an input condition Pre: P×T→N;
an output condition Post: P×T→N; and
an initial marking M: P→N.

Algebraic Petri nets add a collection of extensions to the elements of ordinary Petri nets to take advantage of tokens that carry values. Each place or location in the Petri net is also assigned a data type and the place or location can only hold tokens of its assigned data type. Incoming edges of a transition have conditions, the transition is only enabled when some set of tokens from the source places or locations satisfy the full set of conditions for the incoming edges. The conditions for the incoming edges of a transition can reference the values form other incoming edges of the same transition. The edges going out of a transition may have expressions specifying how to compute the values of tokens being produced by the transition. When a transition is successfully performed or “fired,” the expressions on the transition's outgoing edges are evaluated to produce new tokens to feed into the place or location at an end of the edge.

The formal definition of algebraic Petri nets is as follows; see Maltseff, P. A., Leskin, A. A., Spiridonov, A. M. (1990), Petri Nets in Simulation and Control, Leningrad, Science, 134p. (in Russian).

The algebraic Petri net is defined as N=(P, T, A, V, M₀), where P={p¹, p², . . . , pⁿ} is a finite nonempty set of positions, T={t¹, t², . . . , t^{m}} is a finite nonempty set of transitions, A is a finite alphabet, V: [P×T]∪[T×P]→A^{α} is a mapping marking arcs between positions and transitions(or transitions and positions), A^{α} is a free monoid over A with an empty string e, and M₀: P→A^{α} is an initial marking of the positions.

The existence of arcs between positions (transitions) and transitions (positions) is defined by the next rule. If V(a,b)=e, where e is an empty string, then a and b are not connected, aεP, bεT, or bεP, aεT. If V(a,b)=w, where wε A^{α}, then a and b are connected and the arc between them is marked by the word w. The set of inputs for the element aεP∪T is as follows,

G⁺(a)={bεP∪T: V(b,a)≠e}.

The output set is defined symmetrically,

G⁻(a)={bεP∪T: V(a,b)≠e}.

The state of the net is defined by words marking positions. If the word M(pⁱ), pⁱεP marks the place pⁱ, then vector M represents the marking of the entire net, M=[M(p¹), M(p²), . . . , M(pⁿ)]. The words in positions are modified after the “fire” of transitions from the set T. As we can see, the behavior of transitions determines the dynamic of algebraic nets.

The transition t, tεT has a firing concession at a marking M if for all places pⁱ, pⁱεG⁺(t) a word V(pⁱ, t) is a left multiplier of M^{m}(pⁱ), where M^{m}(pⁱ) is a mirror string of M(pⁱ).

The fire of the transition tεT, which has the concession on the marking M₁, leads to the new marking M₂ (we will indicate it as M₁ [t]>M₂), where M₂ (pⁱ)=F[V(pⁱ,t), M₁ (pⁱ)] [symbol] V(t, pⁱ), ∀pⁱεP, where F[a, ba]=b, [symbol] is the operation from the free monoid A^{α}.

To prevent the net from the blocking, the set of words W marking outputs G⁻(a) shall be a codex, which is defined as follows.

Let A={a, b, c, d, . . . } be a finite alphabet and A^{α} be a free monoid over A. The finite nonempty set X⊂A^{α} is a codex system (or briefly a codex) if any concatenation of elements from X allows only unique decomposition of this concatenation into the sequence of elements from X. This means that X^{α}=(X*, [symbol] ,e) is a free monoid over X, where X* is a set of all possible finite sequences of elements from X, [symbol] is the operation of the concatenation, and e is an identity element.

The codex X is decodable for the finite number of steps equal to d, if the implication (∀x₁, x₂, εX, ∀u₁,u₂εX*, ∀xεX^{d}, x₁u₁=x₂xu₂) [symbol] (x₁=x₂) is true.

This means that the wrong decomposition of any word from X* will be detected before d^{th} step.

| | Firing | Marking | | | | |
|---|---|---|---|---|---|---|
| Step | transition | p1 | p2 | p3 | p4 | p5 |
| 0 | | mmm | rrr | e | e | a |
| 1 | t¹ | mm | rrr | n | e | k |
| 2 | t² | mm | rr | n | s | a |
| 3 | t³ | m | rr | nn | s | k |
| 4 | t⁴ | m | r | nn | ss | a |
| 5 | t⁵ | e | r | nnn | ss | k |

FIG. 5B shows an example of the algebraic Petri net that simulates a sequential work of two processes defined as t¹ and t². If the initial marking of the net is M(p¹)=mmm, M(p²)=rrr; M(p³)=e; M(p⁴)=e; M(p⁵)=a, where e is an identity element, than the transition t¹ has the firing concession on the marking M, and the transition t² hasn't the firing concession. The result of the first five steps of the simulation is as follows.

It is easy to see that a marking assigned to a particular position determines the types, operations and functions which can be associated to the expressions utilized on the net, for example functions on the arcs. The sets P, T, A and N have analogous significance to the vertexes and precedence functions sets defined for the ordinary Petri nets. Finally, initial marking maps the positions or locations on the net associating those places or locations to specific elements of a scheme of a particular end user entity.

A schema's elements association with the token may advantageously make the contemplated model more compact, however, the complexity of the all relevant functions may require incorporation of an additional validation function that determines whether or not a given mapping of schemas is valid against every and all schemas documents.

Operation of an exemplary embodiment of a subject based communication facilitation system will now be described in greater detail. While reference is made throughout the following discuss to the embodiments of FIGS. 1 and 2, the methods may be employed with the other described embodiments, as well as even other embodiments, with or without modification.

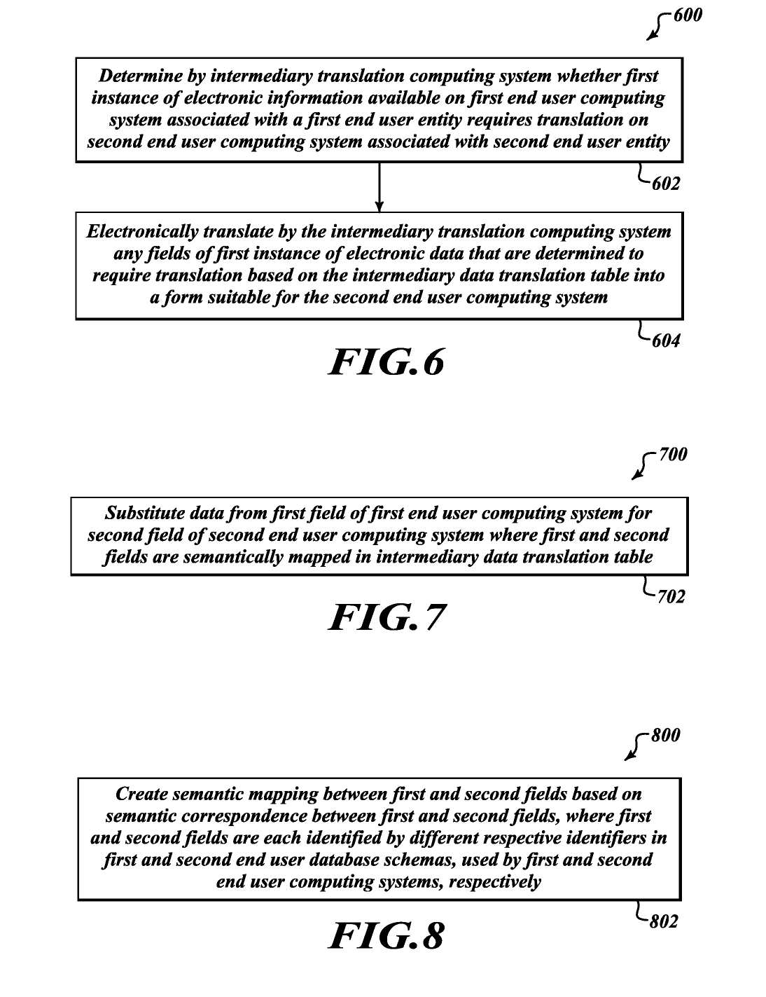

FIG. 6 shows a method 600 of operating at least one intermediary translation computing system in a networked environment to facilitate an exchange of electronic data between various end user computing systems having at least partially incompatible formats, according to one illustrated embodiment.

At 602, the intermediary translation computing system determines whether a first instance of electronic information available on a first end user computing system associated with a first one of the end user entities requires translation for use of the first instance of electronic information by a second end user computing system associated with a second one of the end user entities.

At 604, the intermediary translation computing system electronically translates any fields of the first instance of electronic data that are determined by the intermediary translation computing system to require a translation based on the intermediary data translation table into a form suitable for the second end user computing system.

The determining 602 and the electronically translating 604 may be executed in response an attempt by the first end user computing system to access the first instance of electronic information stored on a second end user computing system operated by a second entity. The determining 602 and the electronically translating 604 may be executed in response to an attempt by the first end user computing system to display the first instance of electronic information stored on a second end user computing system operated by a second entity. The determining 602 and the electronically translating 604 may be executed in response to a transmission to the first end user computing system of the first instance of electronic information stored on a second end user computing system operated by a second entity. Thus, any type of access or use may cause the translation to occur.

FIG. 7 shows a method 700 of electronically translating any fields of a first instance of electronic data that are determined to require a translation, according to one illustrated embodiment. The method 700 may be employed in performing the electronic translation 604 of the method 600 (FIG. 6).

At 702, the intermediary translation computing system electronically translates any fields of the first instance of electronic data that are determined by the intermediary translation computing system to require a translation by substituting data from a first field of a first end user computing system for a second field of a second end user computing system where the first and the second fields are semantically mapped in the intermediary data translation table. Thus, electronic information stored under a first identifier according to a first schema may be provided under a different identifier of a second schema. The fields or identifiers may, for example, be semantically related.

FIG. 8 is a flow diagram of a method 800 of creating an intermediary data translation table by semantic mapping, according to one illustrated embodiment. The method 800 may be employed, for example, in addition to the method 600 (FIG. 6).

At 802, the intermediary translation computing system creates a semantic mapping between the first and the second fields by based on a semantic correspondence between the first and the second fields, where the first and the second fields are each identified by different respective identifiers in a first end user database schema and a second end user database schema. The first and the second end user database schemas may be used by the first end user computing system and the second end user computing system, respectively.

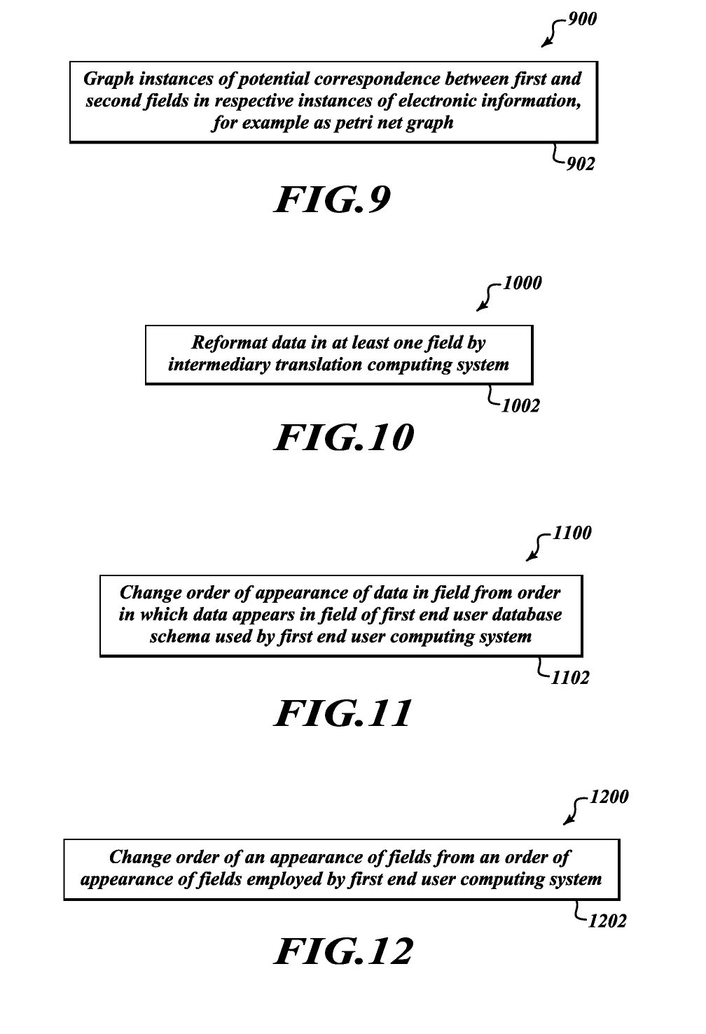

FIG. 9 is a flow diagram of a method 900 of graphing to create a semantic map, according to one illustrated embodiment. The method 900 may be employed as part of the semantic mapping 802 of the method 800 (FIG. 8).

At 902, the intermediary translation computing system graphing a number of instances of a potential correspondence between the first and the second fields in respective ones of a number of instances of electronic information. Such may be employed to create a semantic mapping between the first and the second fields based on a semantic correspondence between the first and the second fields. The graphing may include creating a Petri net graph, such as described above.

FIG. 10 is a flow diagram of a method 1000 of reformatting data to electronically translate any fields of the first instance of electronic data that are determined to require a translation, according to one illustrated embodiment. The method 1000 may be employed as part of the electronic translating 604 of the method 600 (FIG. 6).

At 1002, the intermediate translation computing system reformats data or other electronic information in at least one field. For example, the intermediate translation computing system may change how a date is represented. For instance, representation of a month may be changed, such as changing a two digit month indication (e.g., 01) to a three letter month indicator (e.g., Jan) or to a full text month indicator (e.g., January). Various amounts may also be reformatted. For instance, amounts may be reformatted to add or remove a comma between each three place values, and/or to append or remove a symbol such as a dollar sign or other currency indicator. Numerous other changes could be made to the electronic information to conform such to an existing schema associated with an end user entity that is accessing electronic information of another end user entity.

FIG. 11 is a flow diagram of a method of changing an order of appearance of data in a field to electronically translate any fields of the first instance of electronic data that are determined to require a translation, according to one illustrated embodiment. The method 1100 may be employed as part of the electronic translating 604 of the method 1100 (FIG. 6).

At 1102, the intermediate translation computing system changes an order of appearance of the data in a field from an order in which the data appears in a field of a first end user database schema used by the first end user computing system. For instance, the intermediate translation computing system may change a date from a month, day, year representation to a day, month, year representation.

FIG. 12 is a flow diagram of a method 1200 of changing an order of appearance of fields to electronically translate any fields of the first instance of electronic data that are determined to require a translation, according to one illustrated embodiment. The method 1200 may be employed as part of the electronic translating 604 of the method 600 (FIG. 6).

At 1202, the intermediate translation computing system changes an order of an appearance of fields for a second end user entity from an order of appearance of fields employed by the first end user computing system. For instance, fields on a form or screen display may be spatially reordered or temporally reordered on successive forms or screen displays for one end user entity from that specified by another end user entity.

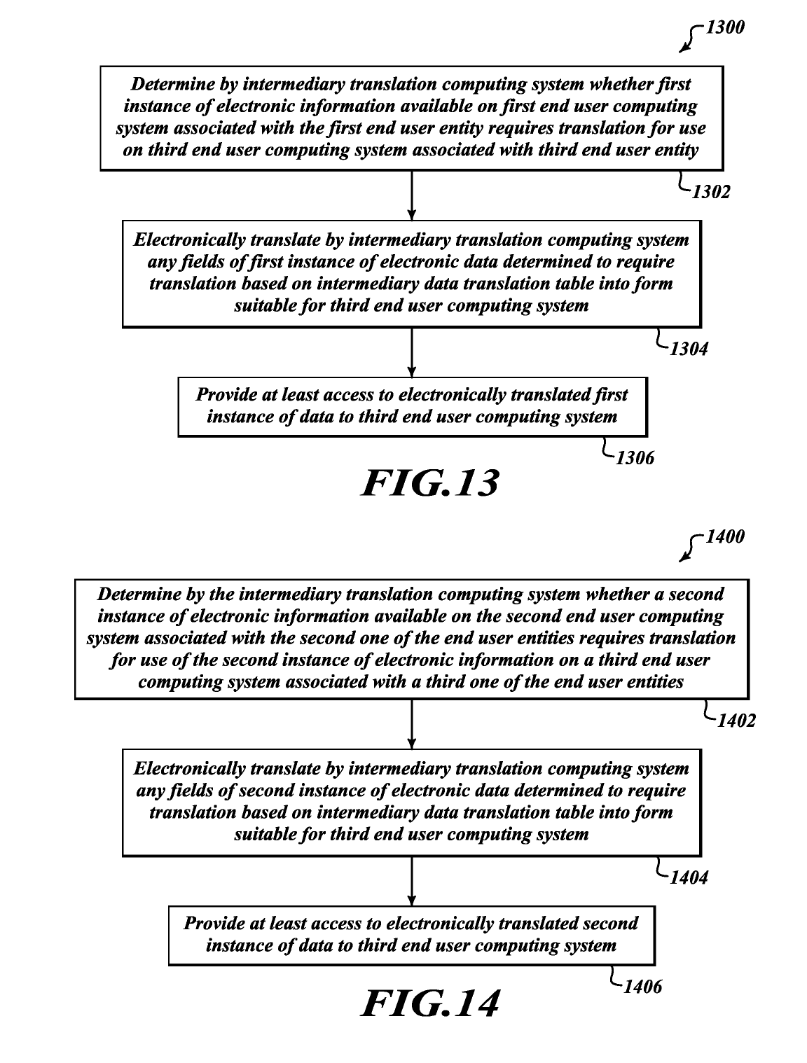

FIG. 13 is a flow diagram of a method 1300 of operating at least one intermediary translation computing system in a networked environment to facilitate an exchange of electronic data between various end user computing systems having incompatible formats by determining whether electronic information requires translation and electronically translating electronic information that requires translation. The method 1300 may be employed in addition to the method 600 (FIG. 6).

At 1302, the intermediary translation computing system determines whether the first instance of electronic information available on the first end user computing system associated with the first one of the end user entities requires translation for use of the first instance of electronic information on a third end user computing system associated with a third one of the end user entities.

At 1304, the intermediary translation computing system electronically translates any fields of the first instance of electronic data that are determined by the intermediary translation computing system to require a translation based on the intermediary data translation table into a form suitable for the third end user computing system. The translation may be a specific translation between a schema associated with the third end user entity and a schema associated with the first end user entity. Such a translation or mapping may have been previously defined by the third end user entity or third end user computing system. Alternatively, the translation may be a specific translation between a schema associated with the second end user entity and a schema associated with the first end user entity. Such a translation or mapping may have been previously defined by the second end user entity or second end user entity computing system, and accepted by the third end user entity or third end user entity computing system.

At 1306, at least access to the electronically translated first instance of data is provided to the third end user computing system. Access may be provided via the intermediary translation computing or may be provided directly between the end user computing systems. Providing at least access includes providing at least the ability to access to the electronic information, receive the electronic information and/or the ability to view or display the electronic information.

FIG. 14 is a flow diagram of a method 1400 of operating at least one intermediary translation computing system in a networked environment to facilitate an exchange of electronic data between various end user computing systems having incompatible formats. The method 1400 may be employed in addition to the method 600 (FIG. 6).

At 1402, the intermediary translation computing system determines whether a second instance of electronic information available on the second end user computing system associated with the second one of the end user entities requires translation for use of the second instance of electronic information on a third end user computing system associated with a third one of the end user entities.

At 1404, the intermediary translation computing system electronically translates any fields of the second instance of electronic data that are determined by the intermediary translation computing system to require a translation based on the intermediary data translation table into a form suitable for the third end user computing system. The translation may be a specific translation between a schema associated with the third end user entity and a schema associated with the first end user entity. Such a translation or mapping may have been previously defined by the third end user entity or third end user computing system. Alternatively, the translation may be a specific translation between a schema associated with the second end user entity and a schema associated with the first end user entity. Such a translation or mapping may have been previously defined by the second end user entity or second end user entity computing system, and accepted by the third end user entity or third end user entity computing system.

At 1406, at least access to the electronically translated second instance of data is provided to the third end user computing system. Access may be provided via the intermediary translation computing or may be provided directly between the end user computing systems. Providing at least access includes providing at least the ability to access to the electronic information, receive the electronic information and/or the ability to view or display the electronic information.

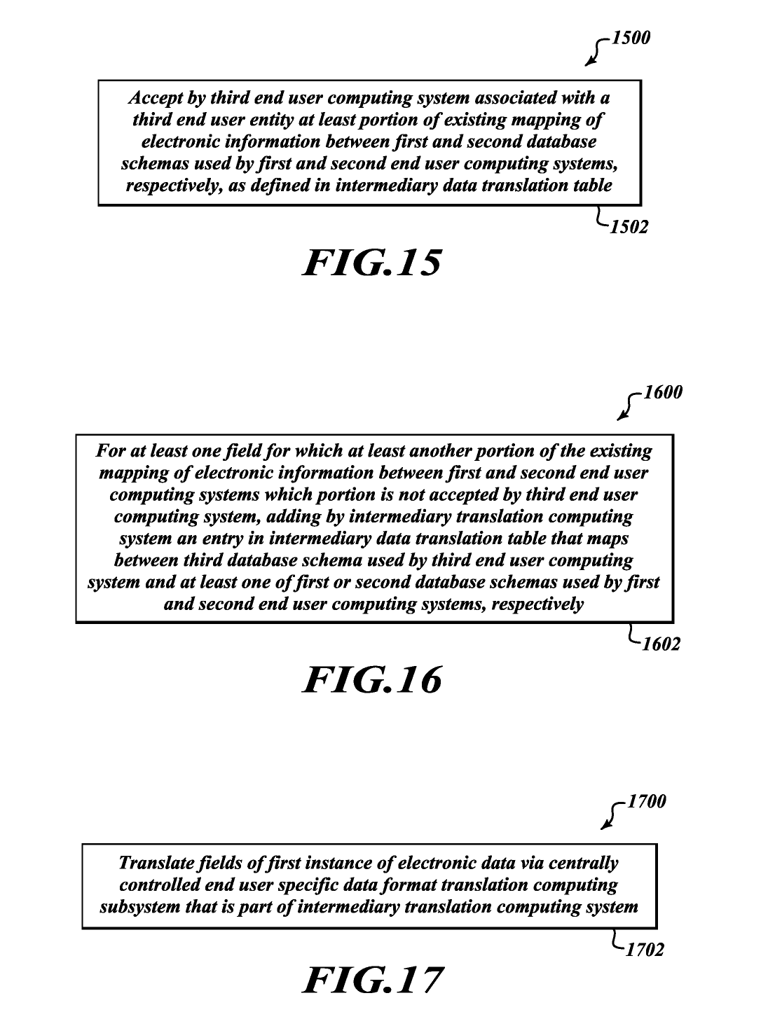

FIG. 15 is a flow diagram of a method 1500 of operating at least one intermediary translation computing system in a networked environment to facilitate an exchange of electronic data between various end user computing systems having incompatible formats. The method 1500 may be employed in addition to the method 600 (FIG. 6).

At 1502, a third end user computing system associated with a third one of the end user entities accepts at least a portion of an existing mapping of electronic information between a first and a second database schema used by the first and the second end user entity computing systems, respectively, as defined in the intermediary data translation table.

Such allows some end user entities to take advantage of mappings or translations defined by other end user entities where such is sufficiently suit to the particular end user entity's desired representation for electronic information. Some embodiments may allow an end user entity to select all of another end user entity's defined relationships or to accept only selected defined relationships. Some embodiments may allow an end user entity to select relationships that were defined by two or more other end user entities. Thus, a fourth end user entity may select some relationships defined between a second and a first end user entity's schemas, and select some relationships between a third and the first end user entity's schemas. Such may be particularly advantageous over requiring each end user entity to completely define a respective mapping or translation between that end user entity's schema and multiple other end user entity schemas.

FIG. 16 is a flow diagram of a method 1600 of operating at least one intermediary translation computing system in a networked environment to facilitate an exchange of electronic data between various end user computing systems having incompatible formats. The method 1600 may be employed in addition to the method 1500 (FIG. 15).

At 1602, for at least one field for which at least another portion of the existing mapping of electronic information between the first and the second end user computing systems which portion is not accepted by the third end user computing system, adding by the intermediary translation computing system an entry in the intermediary data translation table that maps between a third database schema used by the third end user computing system and at least one of a first or a second database schema used by the first and the second end user computing systems, respectively. Thus, for example, a third end user entity may accept some previously defined relationship, mapping or translation between portions of a second end user entity schema and a first end user entity schema. The third end user entity or third end user entity computing system may then define the remaining relationships, mapping or translation between a schema employed by the third end user entity or third end user entity computing system and the schema employed by the first end user entity or first end user entity computing system.

FIG. 17 is a flow diagram of a method 1700 of any fields of the first instance of electronic data that are determined to require a translation. The method 1700 may be employed as part of the electronic translation 604 of the method 600 (FIG. 6).

At 1702, the intermediary translation computing system electronically translates any fields of the first instance of electronic data that are determined by the intermediary translation computing system to require a translation by translating the fields of the first instance of electronic data via a centrally controlled end user specific data format translation computing subsystem that is part of the intermediary translation computing system. Thus, the intermediary translation computing system may maintain control over all tables or mappings used to translate between the respective schemas of the various end user entities or end user entity computing systems.

The various embodiments disclosed herein differ from existing electronic document interchange systems in a variety of ways. For example, existing electronic document interchange systems are limited to electronic documents. The various embodiments disclosed herein do not require the intermediate act of creating an electronic document. Existing electronic document interchange systems are limited to electronic transaction documents such as purchase orders, order acknowledgements, and invoices. The various embodiments disclosed herein can operate with all forms of electronic data whether or not the data is related to a transaction. Existing electronic document interchange systems are one-to-one systems which require each end user entity to create a unique data field translation table for every other end user entity. The various embodiments disclosed herein are many-to-many systems, which create a single data field translation table that can be used by all end users entities. Existing electronic document interchange systems are one-to-one systems which require each end user entity to create a unique data format translation system for every other end user entity. The various embodiments disclosed herein are many-to many systems in which a single data field translation table is linked to a single data format system for each end user entity. An end user entity or associated end user entity computing system trying to send data to another end user entity or associated end user entity computing system only needs to interface with the data field translation table. The data field translation table routes the data to a centrally-managed data format translation system for the end user entity or end user entity associated computing system who will be receiving or accessing the electronic information so that the originators of the electronic information do not have to perform these tasks.

The various embodiments disclosed herein differ from existing electronic data interchange systems (e.g., the Global Data Synchronization Network) for in a variety of ways. For example, existing electronic data interchange systems are standards-based, many-to-many systems which require each end user entity to create a data field translation table that conforms to a standard established by a public or private organization. One of the disadvantages of such systems is that such systems do not work when another end user entity is unable or unwilling to bear the cost of conforming to the standard. Another disadvantage is that every end user entity seeking to access the system must incur the cost of conforming to the standard on which the system is based even, though other end user entities may have identical or substantially similar data field formats.

The various embodiments disclosed herein are also many-to-many systems, but is universal because end user entities are not required to perform the intermediate step of conforming to a standardized data field table. Thus, the various embodiments disclosed herein map each end user's data fields to a single intermediate data field translation table. If that intermediate translation table already includes the same type of data fields as those employed by one of the end user entities, that end user entity's data fields are lined to the existing data fields in the intermediate translation table. This eliminates duplicative costs by allowing each end user entity to benefit, at little or no cost from overlap between that end user entity's data field formats and those of other end user entities.

If an end user entity's schema has data fields that are not found in the intermediate translation table, new data fields are created in the intermediate translation table, and these new data fields are linked to the end user entity's unique data fields, with the possibility that any extra costs will be borne exclusively or partially by that end user entity. If and when one end user entity finds it advantageous to receive the data in another end user entity's unique data fields, the first end user entity can simply add data fields to its own end user entity system, which will allow that end user entity to receive the unique data via the single intermediary data field translation table, with the costs of doing so borne by the end user entity who wants to receive the unique data.

Since existing electronic data interchange systems are standards-based, many-to-many systems, they require each end user to create a data format translation system so that data received in the standardized format is properly translated for that end user entity's data management system. One of the disadvantages of existing systems is that each end user entity must create their own data format translation system even though other end user entities may have identical or substantially similar data format requirements.

The various embodiments disclosed herein are also many-to-many systems, but eliminate the intermediate step of conforming to a standardized data format and centralizes the data format translation function. Thus, data being sent from one end user entity to another end user entity moves through the single, centrally controlled intermediate data field translation table to a centrally-controlled data format translation system in which the data in each field is evaluated to determine whether it is in the format required by the recipient before being sent on to its destination.

If the recipient's data format requirements are identical to or substantially similar to those of other recipients, the cost of reformatting data to meet those requirements can be spread across all recipients with identical or substantially similar data format requirements. If a recipient has unique data format requirements, the cost of reformatting data to meet those requirements could be borne exclusively or partially by that recipient.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary intermediary translation server based system generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of physical signal bearing media include, but are not limited to, the following: recordable type media such as floppy disks, hard disk drives, CD ROMs, digital tape, and computer memory.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet that are commonly assigned to the same assignee of this application are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a networked system that includes at least one intermediary translation computing system that has at least one processor and at least one storage medium that stores an intermediary data translation table which maps at least some types of electronic information for at least two end user entities that each employ different data schemas from one another, the method comprising:
determining by the intermediary translation computing system whether a first instance of electronic information available on a first end user computing system associated with a first one of the end user entities requires translation for use of the first instance of electronic information on a second end user computing system associated with a second one of the end user entities; and
electronically translating by the intermediary translation computing system any fields of the first instance of electronic data that are determined by the intermediary translation computing system to require a translation based on the intermediary data translation table into a form suitable for the second end user computing system.

2. The method of claim 1 wherein electronically translating by the intermediary translation computing system any fields of the first instance of electronic data that are determined by the intermediary translation computing system to require a translation based on the intermediary data translation table includes substituting by the intermediary translation computing system data from a first field of a first end user computing system for a second field of a second end user computing system where the first and the second fields are semantically mapped in the intermediary data translation table.

3. The method of claim 2, further comprising:
creating a semantic mapping between the first and the second fields by the intermediary translation computing system based on a semantic correspondence between the first and the second fields, where the first and the second fields are each identified by different respective identifiers in a first end user data schema and a second end user data schema, the first and the second end user data schemas used by the first end user computing system and the second end user computing system, respectively.

4. The method of claim 3 wherein creating a semantic mapping between the first and the second fields by the intermediary translation computing system based on a semantic correspondence between the first and the second fields includes graphing a number of instances of a potential correspondence between the first and the second fields in respective ones of a number of instances of electronic information.

5. The method of claim 4 wherein graphing a number of instances of a potential correspondence between the first and the second fields in respective ones of a number of instances of electronic information includes creating a Petri net graph.

6. The method of claim 1 wherein electronically translating by the intermediary translation computing system any fields of the first instance of electronic data that are determined by the intermediary translation computing system to require a translation based on the intermediary data translation table includes reformatting data in at least one field by the intermediary translation computing system.

7. The method of claim 6 wherein reformatting data in at least one field by the intermediary translation computing system includes changing an order of appearance of the data in a field from an order in which the data appears in a field of a first end user data schema used by the first end user computing system.

8. The method of claim 6 wherein electronically translating by the intermediary translation computing system any fields of the first instance of electronic data that are determined by the intermediary translation computing system to require a translation based on the intermediary data translation table includes changing an order of an appearance of fields from an order of appearance of fields employed by the first end user computing system.

9. The method of claim 6 wherein the determining and the electronically translating by the intermediary translation computing system are executed in response an attempt by the first end user computing system to access the first instance of electronic information stored on a second end user computing system operated by a second entity, the second entity different from the first entity.

10. The method of claim 1 wherein the determining and the electronically translating by the intermediary translation computing system are executed in response to an attempt by the first end user computing system to display the first instance of electronic information stored on a second end user computing system operated by a second entity, the second entity different from the first entity.

11. The method of claim 1 wherein the determining and the electronically translating by the intermediary translation computing system are executed in response to a transmission to the first end user computing system of the first instance of electronic information stored on a second end user computing system operated by a second entity, the second entity different from the first entity.

12. The method of claim 1, further comprising:
determining by the intermediary translation computing system whether the first instance of electronic information available on the first end user computing system associated with the first one of the end user entities requires translation for use of the first instance of electronic information on a third end user computing system associated with a third one of the end user entities;
electronically translating by the intermediary translation computing system any fields of the first instance of electronic data that are determined by the intermediary translation computing system to require a translation based on the intermediary data translation table into a form suitable for the third end user computing system; and
providing an access to the electronically translated first instance of data to the third end user computing system.

13. The method of claim 1, further comprising:
determining by the intermediary translation computing system whether a second instance of electronic information available on the second end user computing system associated with the second one of the end user entities requires translation for use of the second instance of electronic information on a third end user computing system associated with a third one of the end user entities;
electronically translating by the intermediary translation computing system any fields of the second instance of electronic data that are determined by the intermediary translation computing system to require a translation based on the intermediary data translation table into a form suitable for the third end user computing system; and
providing at least access to the electronically translated second instance of data to the third end user computing system.

14. The method of claim 1, further comprising:
accepting by a third end user computing system associated with a third one of the end user entities at least a portion of an existing mapping of electronic information between a first and a second database schema used by the first and the second end user computing systems, respectively, as defined in the intermediary data translation table.

15. The method of claim 14, further comprising:
for at least one field for which at least another portion of the existing mapping of electronic information between the first and the second end user computing systems which portion is not accepted by the third end user computing system, adding by the intermediary translation computing system an entry in the intermediary data translation table that maps between a third data schema used by the third end user computing system and at least one of a first or a second database schema used by the first and the second end user computing systems, respectively.

16. The method of claim 1 wherein electronically translating by the intermediary translation computing system any fields of the first instance of electronic data that are determined by the intermediary translation computing system to require a translation based on the intermediary data translation table into a form suitable for the second end user computing system includes translating the fields of the first instance of electronic data via a centrally controlled end user specific data format translation computing subsystem that is part of the intermediary translation computing system.

17. A networked system, comprising:
at least one intermediary translation computing system that mediates between a number of end user computing systems, the at least one intermediate computing system having at least one processor and at least one storage medium that stores an intermediary data translation table which maps at least some types of electronic information for multiple ones of the end user computing systems that each employ different schemas from one another, the at least one intermediary translation computing system configured to cause an electronic translation of at least some of a number of fields of a first set of electronic information that is stored by a first one of the end user computing systems and which at least some fields require a translation to be in a form suitable for a second one of the end user computing systems.

18. The networked system of claim 17 wherein the at least one intermediary translation computing system substitutes data from a first field of a first one of the schemas which first one of the schemas is used by a first one of the end user computing systems for a second field of a second one of the schemas which second one of the schemas is used by a second one of the end user computing systems where the first and the second fields are mapped in the intermediary data translation table based on a semantic relationship between the first and the second fields to at least partially cause the electronic translation of the at least some of the number of fields of the first set of electronic information.

19. The networked system of claim 17 wherein the at least one intermediary translation computing system is further configured to create a mapping between a first field of a first one of the schemas which first one of the schemas is used by a first one of the end user computing systems and a second field of a second one of the schemas which second one of the schemas is used by a second one of the end user computing systems based at least in part on a semantic correspondence between the first and the second fields as represented by a graph of a number of instances of a potential correspondence between the first and the second fields in respective ones of a number of instances of electronic information.

20. The networked system of claim 17 wherein the at least one intermediary translation computing system reformats data from at least one field of a first one of the schemas, which first one of the schemas is used by a first one of the end user computing systems, and at least partially causes the electronic translation of the at least some of the number of fields of the first set of electronic information.

21. The networked system of claim 17 wherein the at least one intermediary translation computing system changes an order of an appearance of fields from an order of appearance of fields defined by a first one of the schemas which first one of the schemas is used by a first one of the end user computing systems and at least partially causes the electronic translation of the at least some of the number of fields of the first set of electronic information.

22. The networked system of claim 17 wherein the at least one intermediary translation computing system is further configured to cause an electronic translation of at least some of a number of fields of the first set of electronic information that is stored by the first one of the end user computing systems and which at least some fields require a translation to be in a form suitable for a third one of the end user computing systems.

23. The networked system of claim 17 wherein the at least one intermediary translation computing system is further configured to cause an electronic translation of at least some of a number of fields of a second set of electronic information that is stored by the second end user computing system and which at least some fields require a translation to be in a form suitable for a third one of the end user computing systems.

24. The networked system of claim 17 wherein the at least one intermediary translation computing system is further configured to update the intermediary data translation table to reflect an acceptance by a third one of the end user computing systems of at least a portion of an existing mapping of electronic information between a first and a second one of the schemas which first and second one of the schemas are respectively used by the first and the second ones of the end user computing systems, as defined in the intermediary data translation table.

25. The networked system of claim 24 wherein the at least one intermediary translation computing system is further configured to update the intermediary data translation table to add an entry in the intermediary data translation table that maps between a third one of the schemas which third one of the schemas is used by a third one of the end user computing systems and at least one of a first or a second one of the schemas which first or second one of the schemas is used respectively by the first and the second ones of the end user computing systems, for at least one field for which at least another portion of the existing mapping of electronic information between the first and the second end user computing systems is not accepted by the third end user computing system.
